(19) United States
(12) Patent Application Publication
(10) Pub. No.: US 2026/0344967 A1
(43) Pub. Date: Nov. 5, 2026

(54) FLAT MOP FOR A CLEANING STATION WITH A VERTICAL ORIENTATION, AND CLEANING STATION

(71) Applicant: Carl Freudenberg KG, Weinheim (DE)

(72) Inventors: Marc HEILAND, Worms (DE); Helmut HOFMEISTER, Weinheim (DE)

(21) Appl. No.: 19/102,865

(22) PCT Filed: Jun. 23, 2023
(86) PCT No.: PCT/EP2023/067174

§ 371 Date: Feb. 11, 2025

(30) Foreign Application Priority Data
Aug. 12, 2022 (DE) 10 2022 120 415.4

(51) Int. Cl. A47L 13/254; A47L 13/58; B25G 3/38

(52) U.S. Cl. CPC A47L 13/254; A47L 13/58; B25G 3/38

(57) ABSTRACT

A flat mop for a cleaning station with vertical alignment, including a carrier plate with a wiper cover and a handle which is connected to the carrier plate via a cardan-like joint. The carrier plate with the wiper cover can be pivoted from a wiping position in which the carrier plate rests flat with the wiper cover pointing downwards. The carrier plate with the wiper cover can be pivoted about a pivot axis into a wringing out position in which the carrier plate is aligned parallel to the handle. Means are provided by which the carrier plate is configured with the wiper cover to rotate automatically from the wiping position into the wringing out position when the handle is lifted.

### CROSS REFERENCE TO RELATED APPLICATIONS

This application is a U.S. National Phase application under 35 U.S.C. § 371 of International Application No. PCT/EP2023/067174, filed on Jun. 23, 2023, and claims benefit to German Patent Application No. DE 10 2022 120 415.4, filed on Aug. 12, 2022. The International Application was published in German on Feb. 15, 2024 as WO 2024/032961 A1 under PCT Article 21(2).

### FIELD

The invention relates to a flat mop for a cleaning station with vertical alignment and to a cleaning station with such a flat mop.

### BACKGROUND

A flat mop is known from CN 107456179 B. The document describes a flat mop for a cleaning station with vertical alignment. In such a cleaning station, the flat mop is inserted into a vertical wringing out funnel for wringing out in a vertical position, i.e. with the carrier plate with wiper cover folded against the handle. The flat mop of this type thus has a carrier plate to which a wiper cover is attachable. The carrier plate is connected to a handle via a cardan-like joint. For wringing out, the handle is brought into a vertical position parallel to the carrier plate and fixed in this position by means of suitable fixing devices. In one embodiment, the fixing device consists of a longitudinally displaceable pressure element arranged in the handle, which is pressed onto the outer surface of a curved hinge of the cardan-like joint by means of a spring. This arrangement is intended to fix the carrier plate in both the wringing out and wiping positions. In a further development of this positioning device, the hinge surface has flat sections in both the wringing out and wiping positions to form a flat contact surface for the pressure element. Furthermore, the apex of the hinge can also have a groove into which a corresponding rib on the pressure element engages in the wiping position in order to securely fix the handle in this position.

A disadvantage of this type of flat mop is that the carrier plate has to be rotated from the wiping to the wringing out position with physical effort.

### SUMMARY

In an embodiment, the present disclosure provides a flat mop for a cleaning station with vertical alignment, comprising a carrier plate with a wiper cover and a handle which is connected to the carrier plate via a cardan-like joint. The carrier plate with the wiper cover can be pivoted from a wiping position in which the carrier plate rests flat with the wiper cover pointing downwards. The carrier plate with the wiper cover can be pivoted about a pivot axis into a wringing out position in which the carrier plate is aligned parallel to the handle. Means are provided by which the carrier plate is configured with the wiper cover to rotate automatically from the wiping position into the wringing out position when the handle is lifted.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a flat mop with carrier plate and a lower part of a handle, and a cardan-like joint according to an embodiment of the present disclosure;

FIG. 2 shows an enlarged view of the cardan-like joint of the flat mop from FIG. 1;

FIG. 3 shows a lateral sectional view of the cardan-like joint from FIG. 2;

FIG. 4 shows a lateral sectional view of the cardan-like joint from FIGS. 2 and 3 with the carrier plate and a stem in parallel alignment;

FIG. 5 a) and 5 b) show perspective and lateral sectional views, respectively, of a middle joint element according to an embodiment of the present disclosure;

FIG. 6 a)-6 e) show a sequence of movements when guiding the pressure element along the outer contour according to an embodiment of the present disclosure;

FIG. 7 a)-7 e) show a sequence of movements during automatic movement of the carrier plate from a horizontal to a vertical position according to an embodiment of the present disclosure;

FIG. 8 a)-8 i) show outer contours calculated for different coefficients of friction according to embodiments of the present disclosure;

FIG. 9 a) and 9 b) show schematic principle sketches of a position of angles a and B relative to an outer contour (a), according to an embodiment of the present disclosure with angle specifications according to the exemplary embodiment (b); and

FIG. 10 shows a schematic principle sketch of a flat mop with a large distance between a carrier plate and a pivot axis.

### DETAILED DESCRIPTION

In an embodiment, the present disclosure provides a flat mop of the type mentioned above in such a way that the carrier plate with wiper cover can be easily and conveniently rotated into a wringing out position parallel to the handle without the user having to exert physical effort. A cleaning station with such a flat mop is also provided.

According to an embodiment of the present disclosure, a flat mop for a cleaning station with vertical alignment is provided, comprising a carrier plate with a wiper cover and a handle connected to the carrier plate via a cardan-like connection, wherein the carrier plate with the wiper cover is pivotable from a wiping position, in which the carrier plate with the downward-facing wiper cover rests flat, is pivotable about a pivot axis into a wringing out position in which the carrier plate with the wiper cover is aligned parallel to the handle, means are provided by which, when the handle is lifted, the carrier plate with the wiper cover rotates automatically from the wiping position into the wringing out position.

According to the present disclosure, automatically means that the carrier plate rotates from the wringing out position to the wiping position solely by the action of these means, without direct manual intervention on the carrier plate or by manually operated levers or electrically driven or the like.

These means preferably act mechanically.

According to a preferred embodiment of the present disclosure, these means comprise an outer contour associated with the cardan-like joint, and a longitudinally displaceable spring-loaded pressure element cooperating with the outer contour, which is associated with the end of the handle.

The handle end and the cardan-like joint with the outer contour are fixed in their radial distance to the pivot axis for pivoting from the wiping position to the wringing out position via the articulated connection. Thus, the outer contour of the cardan-like joint forms a kind of guide for the longitudinally displaceable spring-loaded pressure element. Preferably, the longitudinally displaceable spring-loaded pressure element is seated on the outer contour under elastic preload. Elastic preload in this context means that the spring-loaded pressure element is compressed to such an extent in every angular position of the handle that it exerts a counter-pressure on the outer contour of the cardan-like joint. The outer contour thus extends in the plane of the pivoting movement of the handle when pivoting from the wiping position to the wringing out position. With a change in the angular position of the handle relative to the pivot axis perpendicular to this plane, the spring-loaded pressure element is guided along the outer contour and moved longitudinally along the direction of the handle depending on the radial distance of the outer contour from the pivot axis. The spring-loaded pressure element is thereby compressed to varying degrees. Embodiments of the present disclosure make use of this effect.

It has thus been surprisingly shown that an automatic rotation of the carrier plate with wiper cover from a wiping position into a position parallel to the handle can be achieved in a simple manner by appropriately configuring the outer contour of the cardan-like joint.

Preferably, the outer contour corresponds to the outer surface of a joint head of the cardan-like joint projecting upwards towards the end of the handle. Preferably, the longitudinally displaceable spring-loaded pressure element rests under elastic preload on the outer surface of the joint head.

According to an embodiment of the present disclosure, the carrier plate has a longitudinal and a transverse direction, and the cardan-like joint has a lower joint element associated with the carrier plate, to which a middle joint element is articulated with a pivot axis in the longitudinal direction, as well as an upper joint element associated with the handle, which is articulated to the middle joint element with a pivot axis in the transverse direction, wherein the joint head is associated with the middle joint element. In this embodiment, the pivot axis for pivoting from the wiping position to the wringing out position is aligned in the transverse direction of the carrier plate.

In general, the pivot axis for pivoting from the wiping position to the wringing out position can extend both longitudinally and transversely to the carrier plate with the wiper cover. In the case of a carrier plate with a greater longitudinal than transverse extent, the pivot axis is usually oriented in the transverse direction, so that the carrier plate with the wiper cover aligns itself parallel to the handle with its greater longitudinal extent and can be introduced into the wringing out station in this vertical position.

Preferably, the outer contour has an apex towards the top, i.e. on the side facing the end of the handle when the handle is aligned vertically, and extends from this apex to an angle of approximately 90° relative to the vertical through the apex at least on one side in the direction of the pivot movement of the handle from the wiping position to the wringing out position in a curved path downwards. The angle of 90 ° corresponds approximately to the parallel alignment of the carrier plate and handle.

The outer contour as a cam guide can extend from the apex point to only one side.

Preferably, however, it is symmetrically formed on both sides.

It has been shown that an outer contour is particularly suitable in which the radial distance of the outer contour to the pivot axis continuously decreases from a predetermined angle downwards to an angle of approximately 90° relative to the vertical through the apex point.

The specified angle, as described further below, is the angle from which the carrier plate with wiper cover should automatically rotate upwards into the wringing out position, i.e. into a position parallel to the handle, when the handle is lifted. This angle is freely selectable.

Calculations have shown that the carrier plate rotates very reliably into the parallel position to the handle if, from the specified angle up to the angle of approximately 90° relative to the vertical through the apex, for each point on the outer contour with a radial distance r to the pivot axis, the angle between the tangent on the outer contour and the perpendicular to the radial distance r at this point is ≥arctan (μ), wherein μ is between 0.1 and 0.9, preferably between 0.3 and 0.5. This angle is also referred to below as the critical angle. This effect is maintained even with slight deviations from the angles calculated according to the above formula, it only worsens with increasing deviation.

The above rule states that the critical angle remains constant or increases from the specified angle with increasing angle relative to the vertical through the apex. As a result, the critical angle itself does not become smaller even when the distance between the reference point on the outer contour and the pivot axis decreases, but remains constant or becomes larger.

A particularly good sliding behavior from the wiping position to the wringing out position is achieved when the outer contour is selected in such a way that the critical angle increases with increasing angle relative to the vertical through the apex.

According to an embodiment of the present disclosure, the outer contour has a constriction in an angular range around 90°, into which the spring-loaded pressure element snaps when the carrier plate is parallel to the handle, in order to fix the handle in the wringing out position. If a constriction is present, then the above conditions for the shape of the outer contour do not apply up to an angle of approximately 90°, but only up to the start of the constriction.

The above value μ includes the sliding friction between the joint element supporting the outer contour and the pressure element. Both components are usually made of plastic, for example POM, PP or PA. For most suitable plastic pairings, the value μ lies between 0.1 and 0.9, preferably between 0.3 and 0.5. This results in a critical angle in the range of 13° and 31°, for example, without limiting the generality.

In an embodiment of the present disclosure, the outer contour is flattened around the apex, preferably in a range of about +/−15° to the vertical, in order to form a flat contact surface for the pressure element. This stabilizes the carrier plate with the wiper cover in the wiping position to prevent it from folding away.

For larger distances a of the center of gravity of the carrier plate with the wiper cover to the pivot axis for pivoting from the wiping position to the wringing out position, it can be advantageous to compensate for the torque exerted by the weight force on the carrier plate with the wiper cover, particularly when the handle is aligned vertically, by modifying the outer contour appropriately. Calculations have shown that even at larger distances a, the carrier plate folds reliably into the wringing out position when the following equation is fulfilled for the outer contour at each contour point:

a·m·9.81 m/sec²·sin(β)<F_{β}·r_{β}·cos(α_{β})·sin(α_{β})
with α=arctan(μ),
wherein a is the distance between the center of gravity of the carrier plate with wiper cover and the pivot axis for pivoting from the wiping position to the wringing out position,
m is the mass of the carrier plate with wiper cover,
β is the angle between the radius from the pivot axis to the contour point relative to the vertical through the apex of the outer contour,
r_{β} the radius to the contour point on the outer contour at the angle β
and μ is between 0.1 and 0.9, preferably between 0.3 and 0.5.

According an embodiment of the present disclosure, the spring-loaded pressure element is arranged inside the handle and is longitudinally displaceable there. A particularly secure guidance over the outer contour can be achieved when a joint fork is used as the upper joint element, the forks of which embrace the outer contour, for example the outer surface of the joint head, on both sides and thus laterally limit the movement of the spring-loaded pressure element.

Preferably, the specified angle is selected such that it corresponds approximately to an outstretched arm's length, so that the user can fold the carrier plate with the mop cover upwards for wringing out or squeezing out with a slight lateral arm movement. It has been shown that an angle <25°, preferably in the range between about 8° to 18° to the vertical direction, is particularly suitable for this purpose, as this range generally covers the different body sizes of the users well.

It is further preferable that the carrier plate with wiper cover does not fold upwards abruptly when the specified angle is reached, but only slides upwards slowly when the carrier plate is lifted slightly. This prevents the carrier plate from folding away unintentionally when the handle is in a tilted position during wiping. In addition to the geometric configuration of the outer contour of the joint head, the sliding friction between the mating surfaces of the joint head and the pressure element is responsible for the speed of sliding. The higher the sliding friction, the slower the carrier plate rotates into the parallel position to the handle. The sliding friction can be adjusted, for example, using suitable material pairings of the two components. Furthermore, surface coatings and/or treatments (smoothing, roughening or similar) can also be provided for influencing the sliding friction.

Another control variable is the preload of the spring-loaded pressure element, i.e. the force with which the spring-loaded pressure element presses on the outer surface with the outer contour.

In practice, it has proven to be advantageous to first determine the outer contour of the outer surface of the joint head facing the handle for a given material pairing, and then to adjust the desired sliding properties via the preload of the spring-loaded pressure element. The person skilled in the art can find the appropriate preload for this by simple trial and error.

Ideally, the preload of the spring is selected such that the carrier plate with wiper cover does not fold away unintentionally due to its own weight and/or slight pressure on the handle when wiping, even when the specified angle is reached, but is held on the floor. If the carrier plate is then lifted slightly, it should slide into the parallel position.

All materials and arrangements that exhibit sufficient elastic deformation are suitable for the spring-loaded pressure element. According to an embodiment of the present disclosure, the spring-loaded pressure element comprises a pressure body which sits on the outer contour and a spring element which exerts the pressure on the pressure body. As a simple and cost-effective solution, a helical spring, in particular made of metal, is preferred as the spring element. The pressure body can be made of plastic, for example, whereby the surface sitting on the outer contour can be optimized with regard to the desired torque transmission. Preferably, this surface has the shape of a half cylinder.

Preferably, without limiting the generality, the carrier plate has a greater linear expansion in the longitudinal direction than in the transverse direction. This corresponds to the usual configuration of the carrier plates in cleaning stations with a vertical orientation. However, the present disclosure is also applicable to flat mops with carrier plates of any geometry, in particular also round or those with greater transverse expansion.

According to the present disclosure, the middle joint element has a joint connection to the lower joint element. A particularly simple structure is achieved when the lower joint element is also fork-shaped and engages in a corresponding opening on the middle joint element.

The outer contour and the spring force of the spring-loaded pressure element must be matched to the weight and geometry of the carrier plate with wet wiper cover in order to achieve the effect according to the present disclosure. With the aid of the specifications in this description, the skilled person can easily find the suitable sizes by simple trial and error.

A cleaning station with vertical orientation according to the present disclosure has a bucket comprising at least one washing out unit and at least one wringing out unit and a flat mop as described above.

Insofar as the present disclosure refers to top, bottom, vertical or horizontal, these indications relate to the flat mop in the wiping position, i.e. with the carrier plate lying horizontally on the floor.

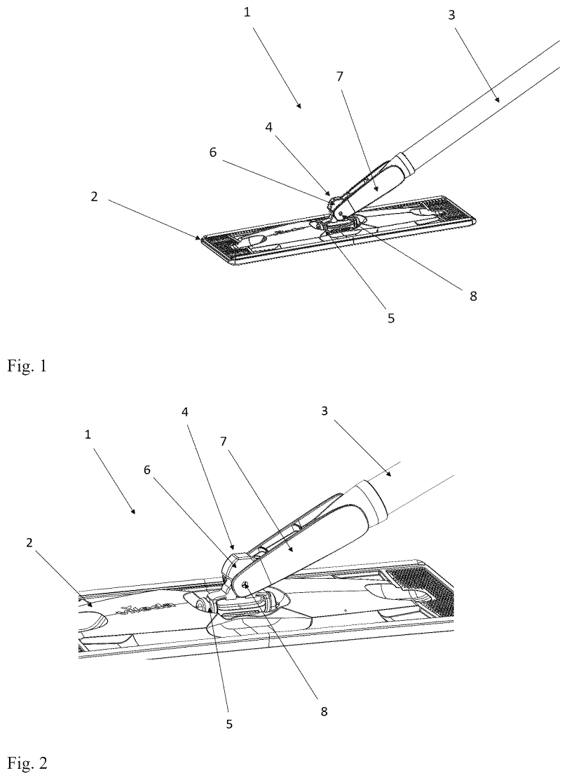

FIG. 1 shows a flat mop 1 according to the present disclosure with a carrier plate 2, which is connectable to a wiper cover. The flat mop 1 according to the present disclosure has a longitudinal and a transverse direction, as well as a handle 3, which is connected to the carrier plate 2 via a cardan-like joint 4. The cardan-like joint 4 has, by way of example, a lower joint element 5 associated with the carrier plate, to which a middle joint element 6 is articulated with a pivot axis in the longitudinal direction, as well as an upper joint element 7 associated with the handle 3, which is articulated to the middle joint element 6 with a pivot axis 8 in the transverse direction.

According to an embodiment of the present disclosure, FIG. 2 shows the cardan-like joint element 4 on the carrier plate 2 (shown here only partially) in detail. The lower joint element 5 is integrated into the carrier plate 2 without limiting the generality. The upper joint element 7 is also attached to the lower end of the handle without limiting the generality. It is exemplarily configured in a fork shape, whereby the two fork arms are articulated relative to the middle joint element 6 with the pivot axis 8 in the transverse direction.

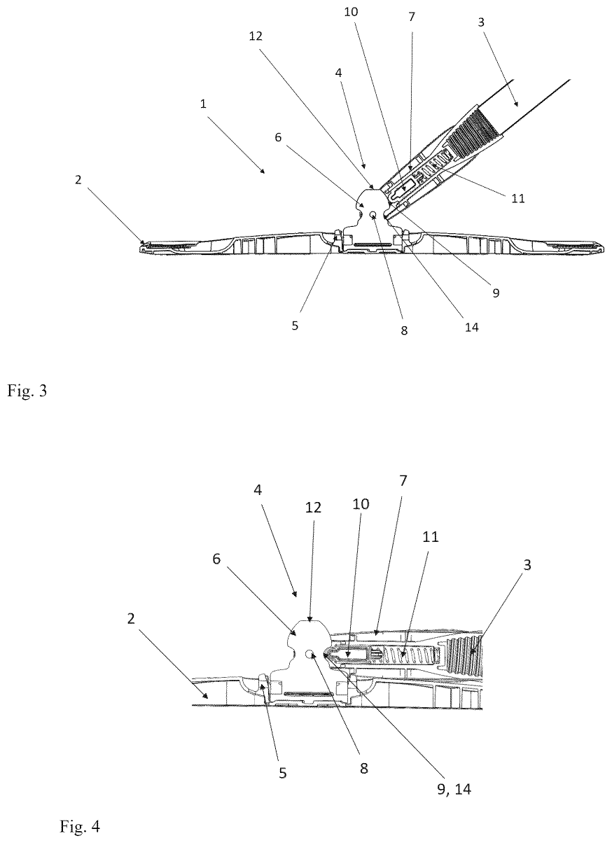

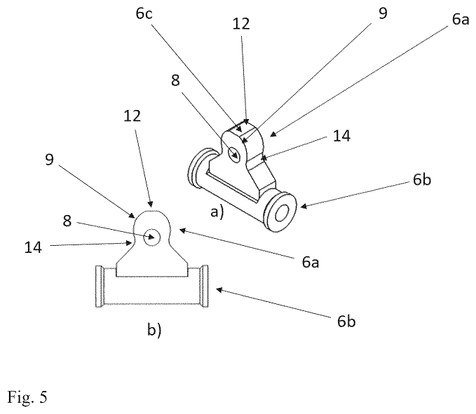

FIG. 3 shows the cardan-like joint 4 from FIG. 2 in a lateral longitudinal sectional view. In the embodiment shown, the carrier plate 2 rests on the floor, and the handle 3 is exemplarily shown in an inclined position relative to the vertical. The central joint element 6 features an upwardly projecting joint head 6a (see FIG. 5), the outer surface of which faces the lower end of the handle 3 with the outer contour 9. At the lower end of the handle 3, a longitudinally displaceable pressure element 10 is arranged, which is pressed against the outer contour 9 via a spring 11. The pressure element 10 sits on the outer surface with the outer contour 9 under preload.

FIG. 4 shows the cardan-like joint element in a parallel position of carrier plate 2 and handle 3. It can be seen that the pressure element 10 is snapped into the constriction 14 of the outer contour 9 of the joint head 6a in accordance with an embodiment of the present disclosure and in this way stabilizes the carrier plate 2 and the handle 3 in this wringing out position. Also the flattened apex region 12 in the outer contour 9 can be seen, by means of which the carrier plate 2 and the handle 3 are stabilized in the wiping position.

In FIG. 5, the middle joint element is shown in a configuration according to the present disclosure, in perspective a) and in a lateral longitudinal sectional view b). The lower connecting element 6b to the lower joint element can be seen. In the assembled state, it extends in the longitudinal direction of the carrier plate and has openings on both sides for the engagement of joint forks. The joint head 6a projects upward from the connecting element 6b. The joint head 6a is configured symmetrically on both sides in relation to a vertical through the apex, without limiting the generality. The flattened area 12 around the apex can be seen for stabilizing the flat mop in the wiping position, as well as the constriction 14 for stabilizing the flat mop in the parallel position to the handle. Furthermore the outer surface 6c with the outer contour 9 can be recognized.

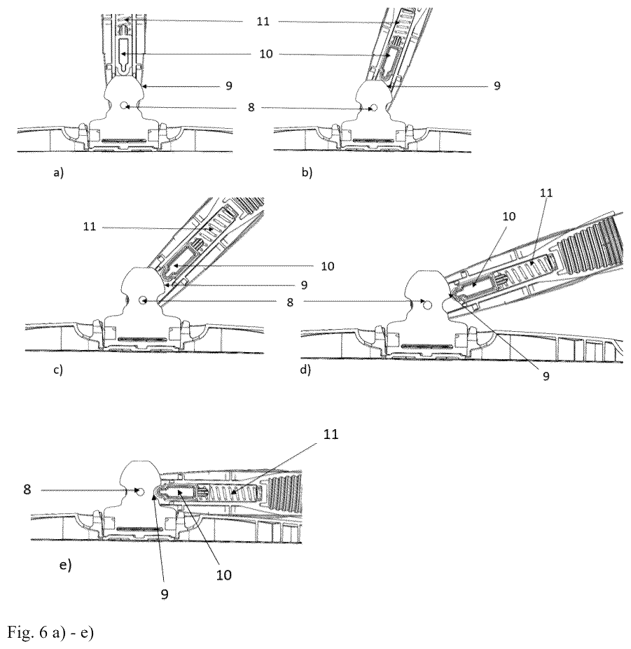

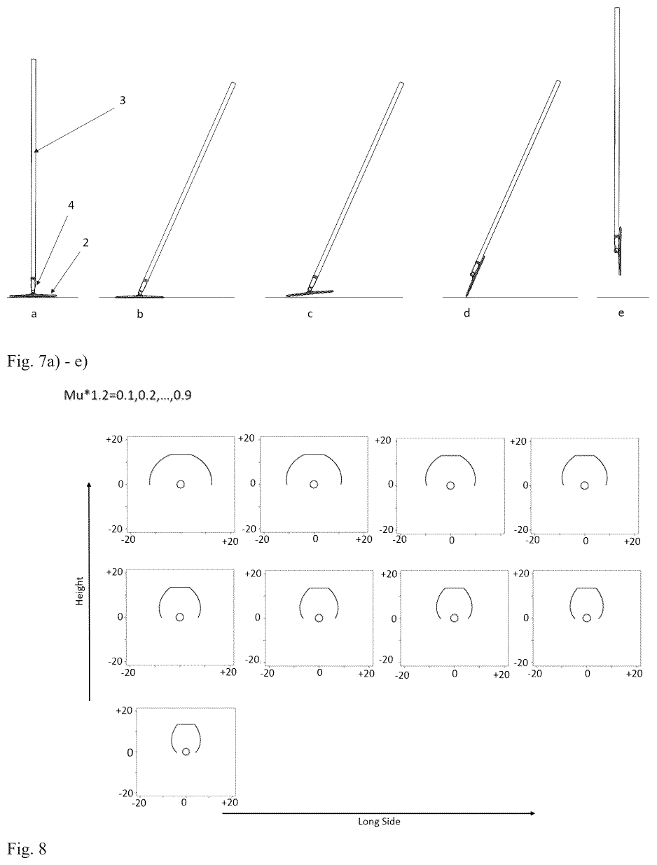

FIG. 6 a) to e) show an example of the sequence of movements for the cardan-like joint in FIGS. 2 to 4 when the pressure element 10 is guided along the outer contour 9 from the perpendicular position of the carrier plate 2 to the handle 3 up to the parallel position. For illustrative reasons, the carrier plate is shown here in a horizontal position, while the handle 3 changes its angular position. In fact, as can be seen in FIG. 7 a) to e), the carrier plate folds up relative to the handle 3.

FIG. 7 a) to e) show that, in an embodiment of the present disclosure, when the handle 3 is tilted from the vertical position, the carrier plate 2 initially remains on the floor due to its own weight, and only when the handle 3 and thereby the weight of the carrier plate is slightly lifted by the user does the carrier plate 2 fold upwards.

FIG. 8 a) to i) show how the outer contour of the outer surface of the joint head becomes increasingly steeper with an increase in the coefficient of friction (μ*1.2=0.1, 0.2, . . . , 0.9). The outer contours were determined using a formula.

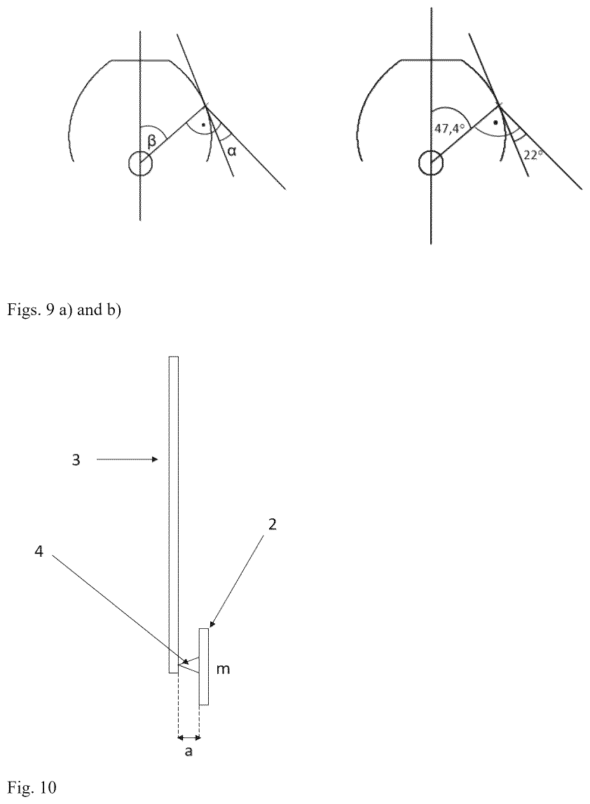

FIG. 9 a) shows in a schematic longitudinal sectional view the critical angle a at a contour point at a radial distance from the pivot axis at an angle β relative to the vertical through the apex. According to an embodiment of the present disclosure, the outer contour is configured such that the critical angle a increases with increasing angle β. FIG. 9 b) shows the arrangement according to FIG. 9 a) with the angle specifications as per the following exemplary embodiment.

FIG. 10 shows a schematic view of a carrier plate 2 aligned vertically and parallel to the handle 3, with its center of gravity located at a distance a from the axis of rotation. As a result, a torque acts on the carrier plate 2 with wiper cover, which can be compensated for by appropriately shaping the outer contour, as described above.

### EXAMPLE

The following was assumed for the calculation of an exemplary embodiment: A carrier plate with a dry wiping pad without limiting the generality was provided. In practice, the weight of a damp or dripping wet wiping pad will be included in the design of the outer contour. The weight of the carrier plate and wiping pad was assumed to be approximately 180 g. This also corresponds to real values. The dimension of the carrier plate in the longitudinal direction was approximately 32 cm in the calculation and 10 cm in the transverse direction. A torque of approximately 0.28 Nm acts on the carrier plate when supported on the shorter side due to the weight force. This torque must be sufficient to align the plate parallel to the floor (see FIG. 7 c).

If half the weight of the handle is added, this would result in a weight of 340 g and a torque of 0.53 Nm.

The outer contour and the spring should interact in such a way that, during a typical deflection of the handle from the vertical in a lateral movement in arm's length of about 15°, a lower torque is generated than that caused by the weight force, so that the carrier plate with the wiper cover in the wiping position does not fold up.

The calculations were therefore based on a spring with a nominal length of 64 mm, which was compressed by 34 mm to generate a preload. With a spring constant of 1.4 N/mm, this results in a spring force of approximately 47.6 N.

The outer contour shown in FIG. 9 b) was determined using an equation in. With a coefficient of sliding friction μ=0.33, a critical angle of 22° was determined. The contour of the joint head calculated in this way is shown in FIG. 9 b). For an angle of 47.4 ° relative to the vertical through the apex of the joint head, the critical angle of 22 ° between the tangent and the perpendicular to the radius is drawn as an example.

The angle of 47.4° corresponds to the deflection of the handle when the wiper plate is lying flat relative to the vertical. The spring-loaded pressure element, which presses on the outer contour at this point, generates a torque (without friction) of approx. 0.17 Nm that acts on the carrier plate.

As a result, the torque generated by the spring and the contour at this point is lower than the torque generated by the weight, and the mop can still be maneuvered very well at this deflection of the handle.

At the angle of 15° a torque of around 0.23 Nm results, which is also much lower than the torque generated by the weight.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A flat mop for a cleaning station with vertical alignment, comprising:
a carrier plate with a wiper cover and a handle which is connected to the carrier plate via a cardan-like joint,
wherein the carrier plate with the wiper cover can be pivoted from a wiping position in which the carrier plate rests flat with the wiper cover pointing downwards,
wherein the carrier plate with the wiper cover can be pivoted about a pivot axis into a wringing out position in which the carrier plate is aligned parallel to the handle, and wherein means are provided by which the carrier plate is configured with the wiper cover to rotate automatically from the wiping position into the wringing out position when the handle is lifted.

2: The flat mop according to claim 1, wherein the means comprise an outer contour, which corresponds to cardan-like joint, and a spring-loaded pressure element, which interacts with the outer contour and is assigned to an end of the handle.

3: The flat mop according to claim 2, wherein the outer contour corresponds to an outer surface of a joint head of the cardan-like joint projecting upwards towards the end of the handle.

4: The flat mop according to claim 3, wherein the spring-loaded pressure element is longitudinally displaceable and sits under elastic preload on the outer surface of the joint head.

5: The flat mop according to claim 1, wherein the carrier plate has a longitudinal and a transverse direction, and the cardan-like joint has a lower joint element, which corresponds to the carrier plate, and to which a central joint element is articulated with a pivot axis in the longitudinal direction, as well as an upper joint element, which corresponds to the handle and is articulated to the central joint element with a pivot axis in the transverse direction, and wherein the joint head corresponds to the central joint element.

6: The flat mop according to claim 2, wherein the outer contour has an apex region towards a top and extends downwards from the apex region to an angle of approximately 90° relative to the vertical through an apex of the apex region at least on one side in a longitudinal direction of the carrier plate in a curved path.

7: The flat mop according to claim 6, wherein a distance of the outer contour to the pivot axis in the transverse direction from at least a predetermined angle relative to vertical through the apex which corresponds to a predetermined lateral deflection of the handle, decreases continuously downwards up to an angle of approximately 90°.

8: The flat mop according to claim 6, wherein from the predetermined angle up to an angle of approximately 90° relative to vertical through the apex, for each point on the outer contour with a radial distance r to the pivot axis in the transverse direction, an angle between a tangent to the outer contour at each respective point and the perpendicular to a radial distance at the respective point is greater than or equal to arctan (μ×1.2), wherein μ is a coefficient of sliding friction of a material combination between surfaces corresponding to each other of the outer contour and the pressure element.

9: The flat mop according to claim 6, wherein the outer contour is flattened in a region around the apex.

10: The flat mop according to claim 2, wherein the outer contour has a constriction in an angular region around 90°, into which the spring-loaded pressure element snaps when the carrier plate is parallel to the handle in order to fix the handle in the wringing out position.

11: The flat mop according to claim 4, wherein the longitudinally displaceable spring-loaded pressure element is guided inside the handle.

12: The flat mop according to claim 5, wherein the upper joint element is a joint fork.

13: The flat mop according to claim 1, wherein a spring action is achieved by a helical spring.

14: A cleaning station with vertical orientation comprising:
a bucket;,
at least one washing out unit;
at least one wringing out unit; and
the flat mop according to claim 1.
